(19) United States
(12) Patent Application Publication
(10) Pub. No.: US 2013/0197959 A1
(43) Pub. Date: Aug. 1, 2013

(54) SYSTEM AND METHOD FOR EFFECTIVE EQUIPMENT RENTAL MANAGEMENT

(71) Applicant: Ankita Gupta, Bangalore (IN)

(72) Inventor: Ankita Gupta, Bangalore (IN)

(73) Assignee: INFOSYS LIMITED, Bangalore (IN)

(21) Appl. No.: 13/532,464

(22) Filed: Jun. 25, 2012

(30) Foreign Application Priority Data
Jan. 31, 2012 (IN) 358/CHE/2012

(51) Int. Cl. G06Q 30/06; G06Q 10/06

(52) U.S. Cl. 705/7.23

(57) ABSTRACT

A system and method for providing a rental management tool is disclosed. Information via a user interface for renting one or more rental items to a customer is received. A project corresponding to a sales order for the customer is generated, wherein the sales order includes a plurality sales order lines, at least one sales order line being a rental item and at least one sales order line being a service item. Each sales order line is converted into a corresponding individual task item in the project. One or more resource requirements are determined for task item(s), wherein at least one candidate resource and associated competency information is identified and displayed. At least one candidate resource is assigned based on selection information received from the user interface. A rental invoice is generated for the sales order and incorporates cost information associated with the plurality of sales order lines and the at least one selected candidate resource.

### RELATED APPLICATION

The present application claims the benefit of priority under 35 U.S.C. 119 to copending Indian Patent Application Serial No. 358/CHE/2012, filed Jan. 31, 2012, and entitled “System and Method For Effective Equipment Rental Management”, all commonly owned herewith.

### FIELD

The present disclosure relates to an equipment rental management solution and method thereof.

### BACKGROUND

Organizations which rent and manage rental equipment (and associated services) today are struggling with inflexible rental terms, limited access to real-time information, and inefficient invoicing cycles as well as difficulty in tracking the location of the rental inventory. The problem is substantial for equipment rental companies which have a large number of rental equipment, short lending cycles and/or large number of rental orders (which may or may not contain a number of rental equipments and services), in which the rental companies need to track the location of the rented inventory at any given point in time.

In particular, existing rental management systems do not possess a single user interface to process both rental as well as service lines for rental orders. Additionally, existing rental management systems do not have capabilities to allow real-time access to the availability of rental items nor an integrated solution to allocate or manage resources on a rental order. Further, existing rental management systems are not well integrated with other data sources that contain information relating to deployment and/or return of rental items. Thus, existing rental management systems are not able to automatically use optimized, customer specific pricing for rental items. This results in rental companies having to resort to inflexible terms for both the period and usage of rental items. Moreover, these non-integrated aspects of existing rental management systems result in sending invoices to customers in an untimely manner.

What is needed is a software solution which enables a rental company to create orders for multiple rental orders and service lines, check the availability of rental inventory on the sales order, track the location of the rental inventory/asset without shifting the ownership of the asset (in case of operating leases). The solution should allow the rental company to define billings, terms, pricing tables and rental periods to suit its specific needs as well as allow the rental company to allocate and manage resources on the rental order.

### SUMMARY

In an aspect, a method for providing a rental management tool is disclosed. The method includes receiving information via a user interface for renting one or more rental items to a customer. The method includes generating a project corresponding to a sales order for the customer, wherein the sales order includes a plurality sales order lines, at least one sales order line being a rental item and at least one sales order line being a service item associated with the rental item. The method includes converting each of the plurality of sales order lines into corresponding individual task items in the project. The method includes determining one or more resource requirements for at least one task item for the project. The method includes identifying at least one candidate resource and associated competency information for the one or more determined resource requirements. The method includes displaying, in the user interface, the at least one candidate resource and associated competency information. The method includes assigning the at least one candidate resource based on selection information received from the user interface and updating the project to reflect the assignment. The method includes generating a rental invoice for the sales order, wherein the rental invoice incorporates cost information associated with the plurality of sales order lines and the at least one selected candidate resource.

In an aspect, a non-transitory computer readable medium having stored thereon instructions for operating a rental management tool is disclosed. The medium comprises computer executable code which when executed by at least one machine, causes the machine to receive information via a user interface for renting one or more rental items to a customer. The code causes the machine to generate a project corresponding to a sales order for the customer, wherein the sales order includes a plurality sales order lines, at least one sales order line being a rental item and at least one sales order line being a service item associated with the rental item. The code causes the machine to convert each of the plurality of sales order lines into corresponding individual task items in the project. The code causes the machine to determine one or more resource requirements for at least one task item for the project. The code causes the machine to identify at least one candidate resource and associated competency information for the one or more determined resource requirements. The code causes the machine to display, in the user interface, the at least one candidate resource and associated competency information. The code causes the machine to assign the at least one candidate resource based on selection information received from the user interface and updating the project to reflect the assignment. The code causes the machine to generate a rental invoice for the sales order, wherein the rental invoice incorporates cost information associated with the plurality of sales order lines and the at least one selected candidate resource.

In an aspect, a network device comprises a network interface configured to allow communications with at least one database. The network device comprises a memory stored thereon computer executable code configured as instructions for operating a rental management tool. The network device comprises a processor coupled to the network interface and the memory. The processor is operative to receive information via a user interface for renting one or more rental items to a customer. The processor is operative to generate a project corresponding to a sales order for the customer, wherein the sales order includes a plurality sales order lines, at least one sales order line being a rental item and at least one sales order line being a service item associated with the rental item. The processor is operative to convert each of the plurality of sales order lines into corresponding individual task items in the project. The processor is operative to determine one or more resource requirements for at least one task item for the project, wherein the one or more resource requirements are stored in the database. The processor is operative to identify at least one candidate resource and associated competency information for the one or more determined resource requirements. The processor is operative to display, in the user interface, the at least one candidate resource and associated competency information. The processor is operative to assign the at least one candidate resource based on selection information received from the user interface and updating the project to reflect the assignment. The processor is operative to generate a rental invoice for the sales order, wherein the rental invoice incorporates cost information associated with the plurality of sales order lines and the at least one selected candidate resource.

In one or more of the above aspects, availability of the rental item is checked for each task item in the project and the rental item is reserved such that the reserved rental item is no longer available for rent for a set period of time. Additionally dispatch information is electronically sent of the reserved rental item to one or more appropriate dispatch locations.

In one or more of the above aspects, a location of the reserved rental item identified in the sales order line is tracked.

In one or more of the above aspects, the sales order line for the rental item further comprises at least a cost quote, a quantity, a delivery location, and time information for renting the rental item.

In one or more of the above aspects, for the selected candidate resource, one or more time entry fields is generated in the user interface for the assigned candidate resource to enter time worked for the project. Time entry input information for assigned resource is received via the user interface and stored the input information for the project. The rental invoice for the project is updated to include cost information associated with the time entry input information for the assigned candidate resource.

In one or more of the above aspects, the candidate time entry input information is associated with repair of the rental item.

In one or more of the above aspects, the resource requirement is customizable via the user interface.

In one or more of the above aspects, the rental management tool in conjunction with an existing business software tool configured to handle rental item information.

In one or more of the above aspects, information is received via the user interface of a returned rental item which requires repair. A repair order line is created for repairing the rental item and resource allocation if performed for the returned rental item. The rental invoice is then updated to reflect costs associated with the repair of the returned rental item.

In one or more of the above aspects, profitability of each rental item in the sales order is tracked by the rental management tool.

### BRIEF DESCRIPTION OF THE DRAWINGS

FIG. 1 illustrates a diagram of an example system environment that utilizes a rental management solution and associated method in accordance with an aspect of the present disclosure;

FIG. 2A illustrates a block diagram of a network device implementing the rental management solution in accordance with an aspect of the present disclosure;

FIG. 2B illustrates a block diagram of the rental management solution in accordance with an aspect of the present disclosure;

FIG. 3 illustrates an example flow chart diagram depicting at least a portion of processes performed by the rental management system in accordance with an aspect of the present disclosure; and

FIG. 4 illustrates an example flow chart diagram depicting at least a portion of processes performed by the rental management solution in accordance with an aspect of the present disclosure.

### DETAILED DESCRIPTION

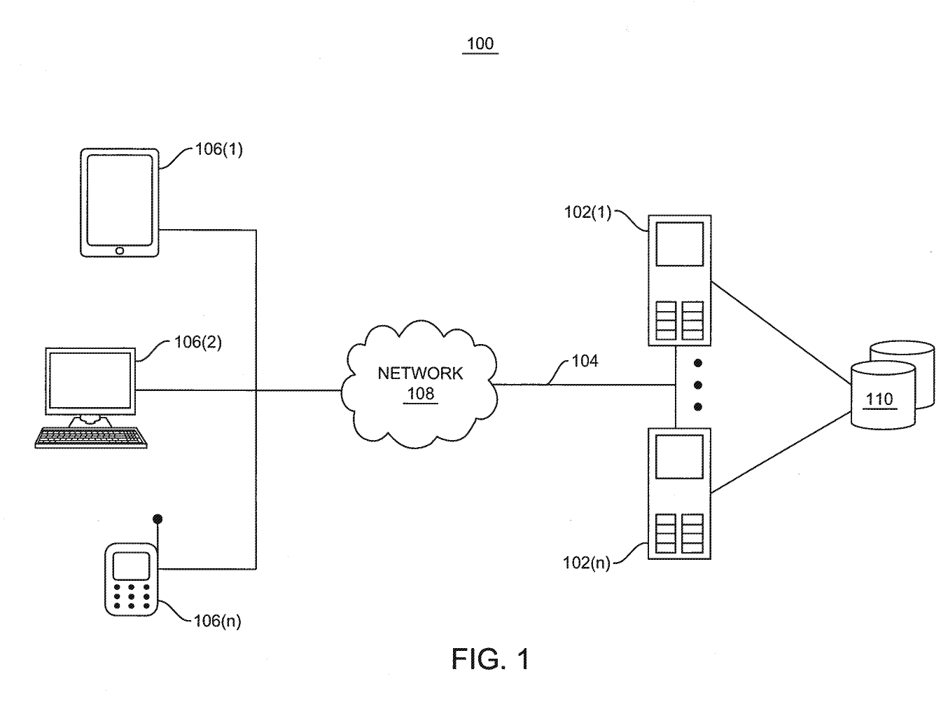

FIG. 1 illustrates a diagram of an example system environment that implements and executes a novel rental management tool or solution and associated method in accordance with an aspect of the present disclosure. In particular, the example system environment 100 includes a plurality of network devices such as one or more servers 102(1)-102(n) and one or more client devices 106(1)-106(n), although the environment 100 could include other numbers and types of devices in other arrangements. It should be noted that the term “network devices” can be referred to as encompassing one or more client devices, one or more servers, virtual machines, cloud computing devices and/or other components in the system 100.

The servers 102(1)-102(n) are connected to a local area network (LAN) 104 and the client devices 106(1)-106(n) are connected to a wide area network 108, whereby the one or more client devices 106(1)-106(n) communicate with the one or more servers 102(1)-102(n) via the wide area network 108 and LAN 104. The servers 102(1)-102(n) comprise one or more network devices or machines capable of operating one or more Web-based and/or non Web-based applications that may be accessed by other network devices (e.g. client devices, other servers) in the network 108. One or more servers may be front end Web servers, application servers, and/or database servers. Such data includes, but is not limited to Web page(s), image(s) of physical objects, user account information, and any other objects and information. It should be noted that the servers 102(1)-102(n) may perform other tasks and provide other types of resources.

One or more servers 102 may comprise a cluster of a plurality of servers which are managed by a network traffic management device (e.g. firewall, load balancer, web accelerator), gateway device, router, hub and the like. In an aspect, one or more servers 102(1)-102(n) may implement a version of Microsoft® IIS servers, RADIUS servers and/or Apache® servers, although other types of servers may be used and other types of applications may be available the on servers 102(1)-102(n). It should be noted that although the client device and/or server may be referred to herein in the plural, it is contemplated that only one client device and/or one server may be considered without being limiting to the language used herein. It should be understood that the particular configuration of the system 100 shown in FIG. 1 are provided for exemplary purposes only and is thus not limiting.

Client devices 106(1)-106(n) comprise computing devices capable of connecting to other computing devices, such as the servers 102(1)-102(n). Such connections are performed over wired and/or wireless networks, such as network 108, to send and receive data, such as for Web-based and non Web-based requests, receiving responses to requests and/or performing other tasks, in accordance with the novel processes described herein. Non-limiting and non-exhausting examples of such client devices 106(1)-106(n) include, but are not limited to, personal computers (e.g., desktops, laptops), mobile and/or smart phones, kiosks, ATMs, tablet devices, PDAs and the like.

In an example, client devices 106(1)-106(n) may be configured to run a Web browser or other software module that provides a user interface for human users to interact with and access the innovation performance module 220. In an example, the user can use the client device 106 to request resources and/or information, as well as submit instructions over the network 108 to the one or more servers 102(1)-102(n) via Web-based or non Web-based applications. One or more Web-based or non Web-based applications may accordingly run on the servers 102(1)-102(n) that provide the requested data to the client device 106(1)-106(n) and/or perform the requested instructions on behalf of the user. In an example, the client device 106 may be a smart phone, tablet, or smart television in which the client devices 106(1)-106(n) communicate with the servers 102(1)-102(n) via a software application.

Network 108 comprises a publicly accessible network, such as the Internet, which handles communication between the client devices 106(1)-106(n) and the servers 102(1)-102(n). However, it is contemplated that the network 108 may comprise other types of private and public networks. Communications, such as requests from client devices 106(1)-106(n) and responses from servers 102(1)-102(n), preferably take place over the network 108 according to standard network protocols, such as the HTTP, UDP, and TCP/IP protocols and the like.

Further, it should be appreciated that the network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate network devices may act as links within and between LANs, WANs and other networks to enable messages and other data to be sent and received between network devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications technologies.

LAN 104 may comprise one or more private and public networks which provide secured access to the servers 102(1)-102(n). These types of existing standardized messaging schemes used between financial institutions over WANs and LANs is well known and is not described in detail herein.

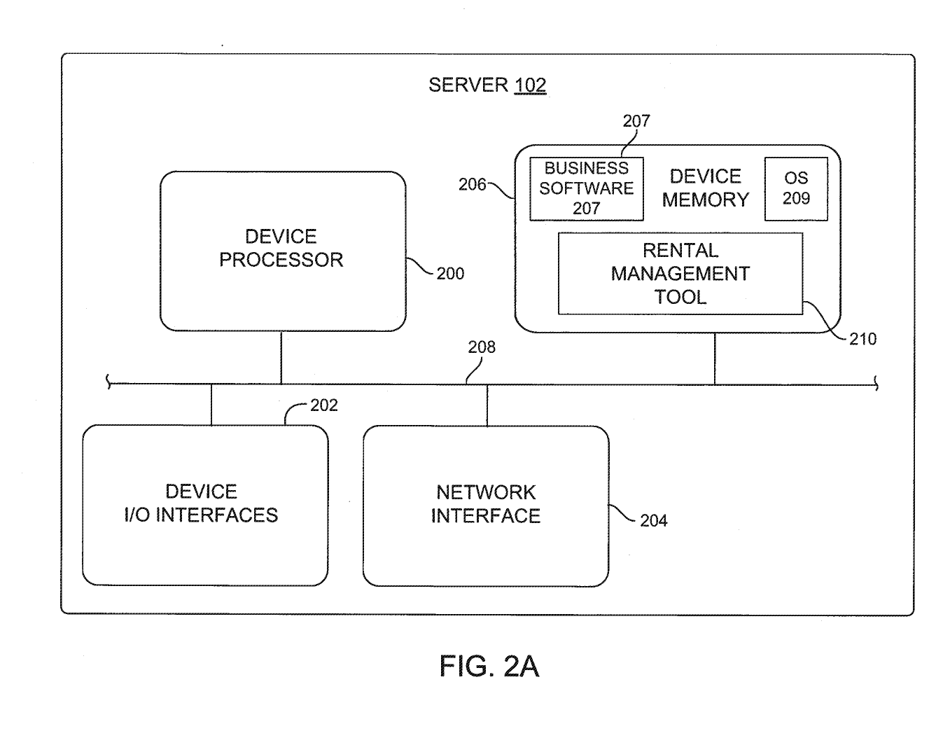

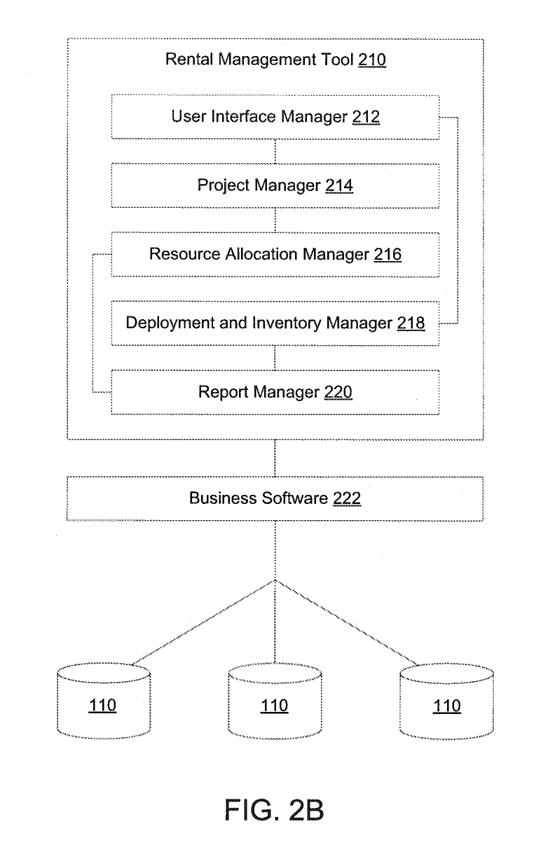

FIG. 2 illustrates a block diagram of a network device shown in FIG. 1 in accordance with an aspect of the present disclosure. The network device 102 is described herein as being a server device 102. However, it should be noted that the network device may alternatively be a client device 106. The network device 102 includes one or more device processors 200, one or more device I/O interfaces 202, one or more network interfaces 204 and one or more device memories 206, all of which are coupled together by one or more buses 208.

As shown in FIG. 2A, an operating system (OS) 209 is stored in device memory 206 and includes a set of programs that manage computer hardware resources and provide common services for the application software. An Enterprise resource planning business software (ERP) 207 is stored in the device memory 206 and sits on top of the operating system. The ERP software 207 integrates internal and external management information across an entire organization, embracing finance/accounting, manufacturing, sales and service, customer relationship management, etc. The ERP software 207 automates this activity with an integrated software application and facilitates the flow of information between all business functions inside the boundaries of the organization as well as manage the connections to outside stakeholders. The Rental Management tool or solution 210 is built up on top of the ERP business software 207 and utilizes its features to provide an end to end solution to manage the various processes in the handling of a rental order.

Device processor 200 comprises one or more microprocessors configured to execute computer/machine readable and executable instructions stored in the respective local device memory 206 or in a remote device memory (not shown). Such instructions are implemented by the processor 200 to perform one or more functions described below. It is understood that the processor 200 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200 is programmed or configured to execute the process in accordance with the teachings as described and illustrated herein of the novel system and method described below.

Device I/O interfaces 202 comprise one or more user input and output device interface mechanisms. The interface may include a computer keyboard, touchpad, touchscreen, mouse, display device, and the corresponding physical ports and underlying supporting hardware and software to enable communications with other network devices in the system 100. Such communications include, but are not limited to, accepting user data input and providing output information to a user, programming, accessing one or more memory devices and administering one or more functions to be executed by the corresponding device and the like.

Network interface 204 comprises one or more mechanisms that enable the client devices 106 and/or the servers 102 to engage in TCP/IP or other communications over the LAN 104 and network 108. However, it is contemplated that the network interface 204 may be constructed for use with other communication protocols and types of networks. Network interface 204 is sometimes referred to as a transceiver, transceiving device, or network interface card (NIC), which transmits and receives network data packets over one or more networks, such as LAN 104 and network 108.

In an example where the network device includes more than one device processor 200 (or a processor 200 has more than one core), each processor 200 (and/or core) may use the same single network interface 204 or a plurality of network interfaces 204 to communicate with other network devices. Further, the network interface 204 may include one or more physical ports, such as Ethernet ports, to couple its respective device with other network devices in the system 100. Moreover, the network interface 204 may include certain physical ports dedicated to receiving and/or transmitting certain types of network data, such as device management related data for configuring the respective device, and the like.

Bus 208 may comprise one or more internal device component communication buses, links, bridges and supporting components, such as bus controllers and/or arbiters. The bus enable the various components of the device 102, such as the processor 200, device I/O interfaces 202, network interface 204, and device memory 206 to communicate with one another. However, it is contemplated that the bus may enable one or more components of its respective network device to communicate with components in other devices as well. Example buses include HyperTransport, PCI, PCI Express, InfiniBand, USB, Firewire, Serial ATA (SATA), SCSI, IDE and AGP buses. However, it is contemplated that other types and numbers of buses may be used, whereby the particular types and arrangement of buses will depend on the particular configuration of the network device 102 which houses the bus.

Device memory 206 comprises non-transitory computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media stores computer readable/machine-executable instructions, data structures, program modules and components, or other data, which may be obtained and/or executed by one or more processors, such as device processor 200. Such stored instructions allow the processor to perform actions, including implementing an operating system for controlling the general operation of the network device 102 (OS 209), and the EBS 207 in particular the rental management tool or solution 210, to perform one or more portions of the novel processes described below.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Such desired information includes data and/or computer/machine-executable instructions and which can be accessed by the network devices 102, 106.

In general, the present system and method is directed to a rental management tool or solution 210 which is configured to be utilized in the equipment rental/service job market, although it is contemplated that the rental management solution can be utilized in other markets and used for other like applications. The rental management solution 210 can be configured to offer pre-designed or customizable project and inventory process flows that allow users to visualize and effectively manage rental and/or service processes. The rental management solution 210 utilizes data stored in the storage devices 110 which relate to cost, billing, resource management and project manufacturing processes, enterprise asset management, inventory, order management and fixed assets capabilities of one or more 3^{rd} party business software.

In particular, the rental management solution 210 is configured to enable the rental company to create orders for multiple rental lines and service lines. The rental management solution 210 is configured to allow the user to check the availability of rental inventory on the sales order and track the location of the rental inventory/asset without shifting the ownership of the asset (in case of operating leases). The rental management solution 210 is also configured to allocate and manage resources and associated costs on the rental sales order by processing each rental/service line a separate task. The rental management solution 210 is configured to define billings, terms, pricing tables and rental periods to suit specific needs of the rental company or customer.

Shown in FIG. 2A is the rental management solution 210 which comprises software, which when executed by one or more processors, causes the network device 102 to perform the processes described below. In the aspect, the rental management solution 210 is at least partially executed on the network device 102, and is accessible by the user using a client device 106 via a web browser and/or dedicated client software program. In an aspect, the rental management solution 210 is at least partially executed on the client device 106 using a Web browser or dedicated client software, whereby information is communicated to and from the client device, via the rental management solution 210.

FIG. 2B illustrates an example block diagram of the rental management tool or solution 210 in accordance with an aspect of the present disclosure. As shown in FIG. 2B, the rental management tool 210 includes a user interface manager 212, a project manager 214, a resource allocation manager 216, a deployment and inventory manager 218 and a reporting manager 220. It should be noted that the components shown in FIG. 2B are exemplary to describe the functions/processes of the rental management solution 210 and are not to be considered limiting in any way.

In the aspect that the rental management solution 210 operates in conjunction with the business software 222, the business software 222 may comprise enterprise resource planning (ERP), customer relationship management (CRM), supply chain management (SCM) implementations and the like. Examples of such business software 222 include, but are not limited to, Oracle™ E-Business Solution (EBS), IBM™ Database Solutions, Alcatel-Lucent™ Enterprise, and the like. The business software 222 may be stored and executed on one or more servers that are remote from the network device in which the rental management solution 210 is stored and executed. It is contemplated, however, that the business software 222 may be stored and executed on the same network device as the rental management solution 210. It is further contemplated that at least a portion of the rental management solution 210 and business software 222 may be stored and/or executed on the same or different client devices 106 is contemplated, in another aspect, that the rental management solution 210 is configured as a standalone solution which makes use of one or more of the ERP, CRM and/or SCM implementations.

As shown in FIG. 2B, the rental management solution 210 is configured to retrieve and store data with respect to one or more storage devices 110 (e.g., databases, file servers, virtual machines). In an aspect, the storage devices 110 may comprise heterogeneous virtualized hardware devices which are accessed, through an appropriate network device, via a virtualization layer. The one or more storage devices 110 contain relevant information associated with the rental process. Such information stored in the database(s) 110 include, but are not limited to, customer information, available/unavailable rental items, available/unavailable rental associated services, personnel resource information, pricing data, information on where rental items/service personnel are located, report and contractual information, deployment status information and the like.

The user interface manager 212 provides a user interface displayed on a screen into which one or more users enter information that is utilized by the rental management solution 210 to perform some or all of the functions described herein. The user interface 212 allows the user to enter information associated with the customer, a sales order for one or more sales order lines, which may include one or more rental items and/or one or more service jobs or items which correspond to the one or more rental items. In an example aspect, a particular rental item may require that one or more individuals perform one or more services for the customer for that rental item. In an example, the service may include, but is not limited to, training to the customer for the rental item, set up of the rental equipment, operation of the rental equipment, dismantling of the rental equipment and the like. The rental management solution 210 stores the information in one or more appropriate storage devices 110. Additionally or alternatively, needed information of an existing project be retrieved by the rental management solution 210 from the appropriate storage device 110 and processed by the rental management solution 210.

The project manager 214 is configured to automatically create a project for a sales order and manage data entered through the user interface along with data retrieved from the storage device(s) 110 to allow effective management of the overall rental project. The project manager 214 operates with the resource allocation manager 216, deployment manager 218 and report manager 220, all of which will be described in more detail below.

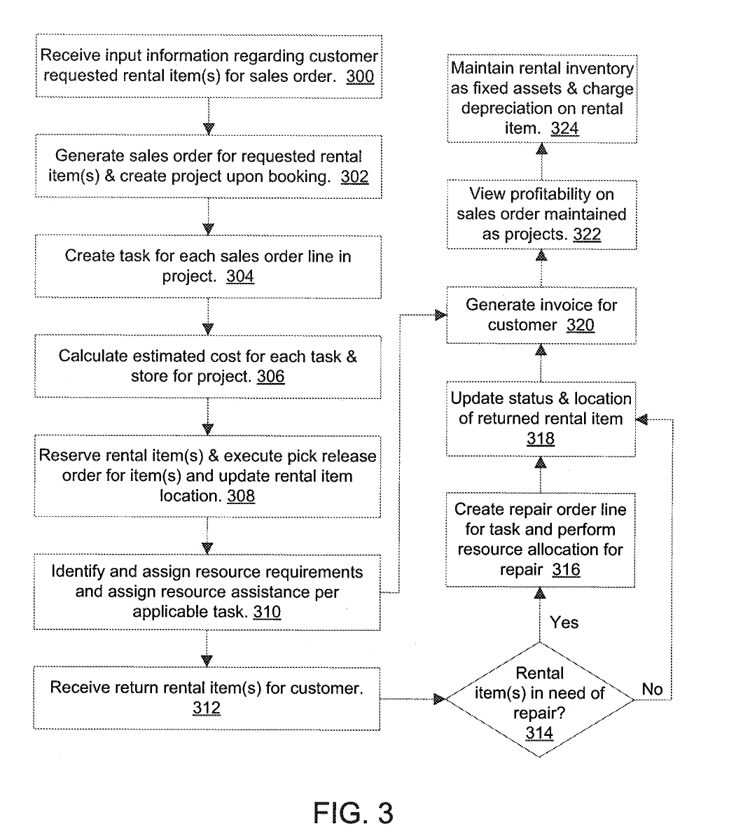

FIG. 3 illustrates a flow chart which represents at least a portion of the process in accordance with an aspect of the present disclosure. In particular, FIG. 3 initiates at the Start Block, in which one or more users of the rental company or representatives thereof accesses the rental management solution 210 and enters input information regarding the customer and a customer's request to rent one or more equipment and service items, via the user interface (Block 300). In particular, the rental management solution 210 allows the user to enter sales information for the sales order via the user interface. Such sales information includes, but is not limited to, customer information, items to be rented, quantity of each item to be rented, date of order, requested date of delivery, location(s) where the item(s) are to be delivered, rental duration(s) of the item(s), unit price(s) of the rented item(s), cost information and the like. The rental management solution 210 also allows the user to enter information regarding required and/or requested services associated with the rental of the equipment item.

Upon entering the relevant information for the sales order, the user interface manager 212 allows the user to finalize (by checking the availability of the rental equipment) or book the sales order via the user interface. Upon booking the sales order, the project manager 214 automatically generates a project that uniquely corresponds to the sales order for the particular ordered rental item(s) for the customer (Block 302). As mentioned herein, the sales order includes one or more sales order lines, wherein the sales order line may be designated as a rental item or service item. The generated project, along with the associated sales information for each sales order line, is then stored by the rental management solution 210 in one or more storage database 110.

The project manager 214 of the rental management solution 210, upon creating the project, creates tasks that correspond to respective rental line and/or service lines within the sales order (Block 304). For example, if the sales order designates that two pieces of equipment (e.g. equipment1, equipment2) are to be rented out and one service item (e.g. personnel to set up equipment), the project manager 214 will create a first task for equipment1, a second task for equipment2 and a third task for the set up personnel. In an aspect, the rental management solution 210 handles each task independently of one another, as will be discussed in more detail below.

As shown in FIG. 3, the rental management solution 210 may be configured to calculate and store preliminary estimated rental cost information for each sales order line in the project (Block 306). Considering that each resource has an associated cost, such as labor, fuel, transport and the like, the resource allocation manager 216 of the rental management tool 210 can estimate as well as track the costs associated with each order line in a project. This allows the rental management solution 210 to provide the customer accurate real time costs for each rental line. However, this is an optional step and is thus not required at this point in the process.

In an aspect, as shown in FIG. 3, the deployment manager 218 performs deployment functions, such as executing one or more pick releases, on the rental item for each task in the project (Block 308). In particular, the deployment manager 218 may convert the locator status of each rental item, per task, from a common locator status to a project locator status (which may depict the customer address/location). By converting the status of the rental item to the project locator status, the rental item is effectively reserved and thus no longer available for rent. Further, by executing the pick release, the deployment manager 218 sends dispatch information to the warehouse(s) from where the reserved equipment(s) will be shipped out. In particular to an aspect, the deployment manager 218 can provide dispatch details to the one or more identified warehouses in which the dispatch details can include relevant information to allow the identified warehouse(s) to effectively reserve and prepare the identified rental equipment to send to the customer.

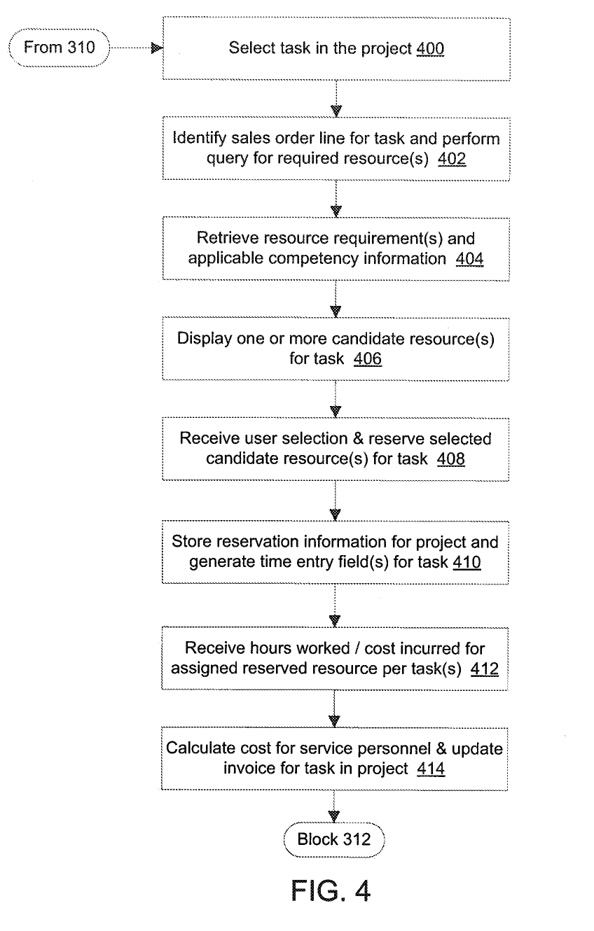

As shown in FIG. 3, the rental management system 210 is able to, for each task, identify, assign and reserve resource(s) for one or more rental items in a project (Block 310). The resource allocation function is described in more detail below with regard to FIG. 4.

FIG. 4 illustrates a resource identification and allocation function performed by the resource allocation manager of the rental management system in accordance with an aspect of the present disclosure. In general, the resource allocation manager 216 of the rental management system 210 identifies, displays, and assigns one or more resource requirements associated with a sales order line.

As shown in FIG. 4, the resource allocation manager 216 selects a task in the project and identifies the sales order line associated with that task (Block 400). The resource allocation manager 216 then performs a look up query in a database 110 to identify one or more required resources for the identified sales order line of the selected task (Block 402). The resource allocation manager 216 thereafter retrieves one or more resource requirements for the sales order line and applicable competency information for the one or more resource requirements (Block 404). For example, a resource requirement may exist in database 110 which requires that one or more service personnel specifically trained in setting up and operating the specific piece of equipment must be assigned a project in which that equipment is being rented out.

In an aspect, the resource requirement may be customized and established by the rental company using the rental management solution 210 for all instances in which the particular item is rented. In an aspect, the resource requirement may be requested and set by a particular customer renting the equipment for a particular project. In an aspect, the resources that are available for allocation may be actual personnel who perform functions which are associated with the item being rented (e.g. set up of equipment, training, operation, tear down).

Once the resource allocation manager 216 identifies the one or more resources/roles required for the sales order line, the resource allocation manager 216 performs a look up in the database 110 to identify and display, via the user interface, one or more available candidate personnel for the required resource (Block 406).

The database 110 can contain pre-established correlation or mapping information between the competency information for a particular rental item and one or more resources which possess skills that satisfy the competency requirement(s). In particular, the rental resource database contains information regarding available personnel and/or supplemental equipment which is to be deployed along with a particular item which is to be deployed to a customer. Additionally, the rental resource database may contain pricing information for employing such personnel (e.g. hourly rate) and/or supplemental equipment for that rental item to be deployed to the customer. Accordingly, the one or more candidate individuals are identified by the resource allocation manager 216 by matching the particular competencies required to perform the resource requirement with the available candidate personnel. Such competencies include, but are not limited to, skill level, years of experience, past reviews, availability, and the like.

In an example aspect, one or more resources may be service personnel that are currently available and thus may be assigned to the task for the rental line. In this example aspect, the resource allocation manager may provide specific information of each available personnel resource, such as skill, quote hourly labor cost, location and the like, so that the user can make an educated decision as to who should be assigned to the task.

Once the user selects one or more of the candidate personnel, the resource allocation manager reserves the selected resource(s) for the particular task (Block 408). In an aspect, the resource allocation manager 216 can notify those individuals of the job and update their status in the database 110 as being reserved and unavailable. Considering the resource is assigned to a particular task, information specific to the task may be automatically applied to the resource, although this is not necessary. For instance, if a service personnel is required to operate the rental item for the entire rental time period, the rental period assigned to the rental item will also apply to the selected service personnel.

In the example aspect where the resource is service personnel, the resource allocation manager may automatically store the reservation information for the task and generate time entry fields in the user interface for the task (Block 410). The time entry fields allow the selected service personnel to enter, via the user interface, the amount of time worked for their corresponding task in the project.

Accordingly, once the rental management solution 210 receives the time entered information from the assigned service personnel (Block 412), the rental management solution 210 can automatically calculate an amount to bill the customer for the services performed by the service personnel for that particular task. Considering that the project is made up of one or more tasks, any calculated costs are automatically updated and incorporated into the overall project (Block 414). In an aspect, the resource requirement may be a supplemental item, whereby the cost entry field(s) may be provided by the resource allocation manager on the user interface, wherein incurred costs may be entered in the cost entry fields. This process is repeated for each applicable task item for the project and then the process then proceeds back to Block 312 in FIG. 3.

Referring back to Block 310 in FIG. 3, it may be contemplated that the invoice may be optionally generated for the customer (Block 320) before the return of the rental item(s). It should be noted that this step is optional, depending on the desire of the rental company and/or the customer. For instance, the rental management solution 210 may generate an additional invoice or update the existing invoice in case repair of the returned rental item is needed, as described below.

As shown in FIG. 3, the rental management solution 210 is able to handle information regarding the return of one or more rental items (Block 312). In particular, once the rental item is returned and checked back into the system, the rental management solution 210 may be automatically notified and the rental management solution 210 can automatically update the status of the item from project locator status back to common locator status.

The rental management solution 210 allows the user to input information as to whether the returned item is in need of repair (Block 314). If not, the status of the returned item is updated to be available and moved from the project locator to the common locator (Block 316). The process then proceeds to Block 318, as described below.

In contrast, if the returned item is in need of repair, the rental management solution 210 generates a repair work order line and performs resource allocation for the repair (Block 316). In performing resource allocation, the rental management solution 210 identifies one or more candidate service personnel and/or replacement parts that are needed to complete the repair. The process is similar to the resource allocation process described in FIG. 4 and is not repeated herein.

Once the repair order line is created, the status of the rental item is updated along with the location of the returned rental item (Block 318). Thereafter, the customer invoice is generated (Block 320). The solution may allow profitability to be viewed on the sales order (Block 322). Further, the solution maintains the rental inventory as fixed assets and charges depreciation of the rental item to the customer (Block 324).

The reporting manager 220 is also able to generate reports to view the profitability on the rental orders/projects and maintain rental inventory as fixed assets in the books of the company, and charges depreciation on these. (Block 323)

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method for providing a rental management tool, the method comprising:
receiving information via a user interface for renting one or more rental items to a customer;
generating a project corresponding to a sales order for the customer, wherein the sales order includes a plurality sales order lines, at least one sales order line being a rental item and at least one sales order line being a service item associated with the rental item;
converting each of the plurality of sales order lines into corresponding individual task items in the project;
determining one or more resource requirements for at least one task item for the project;
identifying at least one candidate resource and associated competency information for the one or more determined resource requirements;
displaying, in the user interface, the at least one candidate resource and associated competency information;
assigning the at least one candidate resource based on selection information received from the user interface and updating the project to reflect the assignment;
generating a rental invoice for the sales order, wherein the rental invoice incorporates cost information associated with the plurality of sales order lines and the at least one selected candidate resource.

2. The method of claim 1, further comprising:
checking, for each task item in the project, an availability of the rental item among one or more appropriate dispatch locations;
reserving the rental item such that the reserved rental item is no longer available for rent for a set period of time; and
electronically sending dispatch information of the reserved rental item to one or more appropriate dispatch locations.

3. The method of claim 2, further comprising tracking a location of the reserved rental item identified in the sales order line.

4. The method of claim 1, wherein the sales order line for the rental item further comprises at least a cost quote, a quantity, a delivery location, and time information for renting the rental item.

5. The method of claim 1, wherein, for the selected candidate resource, the method further comprises:
generating one or more time entry fields in the user interface for the assigned candidate resource to enter time worked for the project;
receiving time entry input information for assigned resource via the user interface and storing the input information for the project; and
updating the rental invoice for the project to include cost information associated with the time entry input information for the assigned candidate resource.

6. The method of claim 5, wherein the candidate time entry input information is associated with repair of the rental item.

7. The method of claim 1, wherein the resource requirement is customizable via the user interface.

8. The method of claim 1, wherein the rental management tool operates in conjunction with an existing third party business software tool configured to handle rental item information.

9. The method of claim 1, further comprising:
receiving information of a returned rental item which requires repair;
creating a repair order line for repairing the rental item;
performing resource allocation on the returned rental item; and
updating the rental invoice to reflect costs associated with the repair of the returned rental item.

10. The method of claim 1 further comprising tracking profitability of each rental item in the sales order.

11. A non-transitory computer readable medium having stored thereon instructions for operating a rental management tool, comprising computer executable code which when executed by at least one machine, causes the machine to:
receive information via a user interface for renting one or more rental items to a customer;
generate a project corresponding to a sales order for the customer, wherein the sales order includes a plurality sales order lines, at least one sales order line being a rental item and at least one sales order line being a service item associated with the rental item;
convert each of the plurality of sales order lines into corresponding individual task items in the project;
determine one or more resource requirements for at least one task item for the project;
identify at least one candidate resource and associated competency information for the one or more determined resource requirements;
display, in the user interface, the at least one candidate resource and associated competency information;
assign the at least one candidate resource based on selection information received from the user interface and updating the project to reflect the assignment;
generate a rental invoice for the sales order, wherein the rental invoice incorporates cost information associated with the plurality of sales order lines and the at least one selected candidate resource.

12. The computer medium of claim 11 wherein the machine is configured to:
check, for each task item in the project, an availability of the rental item among one or more appropriate dispatch locations;
reserve the rental item such that the reserved rental item is no longer available for rent for a set period of time; and
electronically send dispatch information of the reserved rental item to one or more appropriate dispatch locations.

13. The computer medium of claim 12, wherein the machine is further configured to track a location of the reserved rental item identified in the sales order line.

14. The computer medium of claim 11, wherein the sales order line for the rental item further comprises at least a cost quote, a quantity, a delivery location, and time information for renting the rental item.

15. The computer medium of claim 11, wherein, for the selected candidate resource, the machine is further configured to:
generate one or more time entry fields in the user interface for the assigned candidate resource to enter time worked for the project;
receive time entry input information for assigned resource via the user interface and storing the input information for the project; and
update the rental invoice for the project to include cost information associated with the time entry input information for the assigned candidate resource.

16. The computer medium of claim 15, wherein the candidate time entry input information is associated with repair of the rental item.

17. The computer medium of claim 11, wherein the resource requirement is customizable via the user interface.

18. The computer medium of claim 11, wherein the machine operates in conjunction with an existing business software tool configured to handle rental item information.

19. The computer medium of claim 11, further comprising:
receiving information of a returned rental item which requires repair;
creating a repair order line for repairing the rental item;
performing resource allocation on the returned rental item; and
updating the rental invoice to reflect costs associated with the repair of the returned rental item.

20. The computer medium of claim 11, further comprising tracking profitability of each rental item in the sales order.

21. A network device comprising:
a network interface configured to allow communications with at least one database;
a memory stored thereon computer executable code configured as instructions for operating a rental management tool; and
a processor coupled to the network interface and the memory, the processor operative to:
receive information via a user interface for renting one or more rental items to a customer;
generate a project corresponding to a sales order for the customer, wherein the sales order includes a plurality sales order lines, at least one sales order line being a rental item and at least one sales order line being a service item associated with the rental item;
convert each of the plurality of sales order lines into corresponding individual task items in the project;
determine one or more resource requirements for at least one task item for the project, wherein the one or more resource requirements are stored in the database;
identify at least one candidate resource and associated competency information for the one or more determined resource requirements;
display, in the user interface, the at least one candidate resource and associated competency information;
assign the at least one candidate resource based on selection information received from the user interface and updating the project to reflect the assignment; and
generate a rental invoice for the sales order, wherein the rental invoice incorporates cost information associated with the plurality of sales order lines and the at least one selected candidate resource.

22. The network device of claim 21, wherein the processor is configured to:
check, for each task item in the project, an availability of the rental item among one or more appropriate dispatch locations;
reserve the rental item such that the reserved rental item is no longer available for rent for a set period of time; and
electronically send dispatch information of the reserved rental item to one or more appropriate dispatch locations.

23. The network device of claim 21, wherein the processor is further configured to track a location of the reserved rental item identified in the sales order line.

24. The network device of claim 21, wherein the sales order line for the rental item further comprises at least a cost quote, a quantity, a delivery location, and time information for renting the rental item.

25. The network device of claim 21, wherein, for the selected candidate resource, the processor is further configured to:
generate one or more time entry fields in the user interface for the assigned candidate resource to enter time worked for the project;
receive time entry input information for assigned resource via the user interface and storing the input information for the project; and
update the rental invoice for the project to include cost information associated with the time entry input information for the assigned candidate resource.

26. The network device of claim 21, wherein the candidate time entry input information is associated with repair of the rental item.

27. The network device of claim 21, wherein the resource requirement is customizable via the user interface.

28. The network device of claim 21, wherein the processor operates in conjunction with an existing business software tool configured to handle rental item information.

29. The network device of claim 21, wherein the processor is configured to further:
receive information of a returned rental item which requires repair;
create a repair order line for repairing the rental item;
perform resource allocation on the returned rental item; and
update the rental invoice to reflect costs associated with the repair of the returned rental item.

30. The network device of claim 21, wherein the processor is further configured to track profitability of each rental item in the sales order.
